(19) United States
(12) Patent Application Publication
(10) Pub. No.: US 2006/0153210 A1
(43) Pub. Date: Jul. 13, 2006

(54) Method of message distribution between MGC and MGW in NGN

(75) Inventor: Kun Su, Shenzhen (CN)

Correspondence Address: DARBY & DARBY P.C., P. O. BOX 5257, NEW YORK, NY, 10150-5257, US

(73) Assignee: HUAWEI TECHNOLOGIES, CO., LTD., Shenzhen (CN)

(21) Appl. No.: 11/323,138

(22) Filed: Dec. 30, 2005

(30) Foreign Application Priority Data
Jan. 12, 2005 (CN) 200510032810.6

(51) Int. Cl. H04L 12/56

(52) U.S. Cl. 370/401; 370/389

(57) ABSTRACT

The present invention discloses a method of message distribution between Media Gateway Controller and Media GateWay, wherein each Call Control Unit in the Media Gateway Controller having corresponding ID; when the Media Gateway Controller sending request message to the Media Gateway or requesting the Media Gateway to detect an event, the ID of said Call control Unit being added in TransactionID or RequestID in said request message ; when the Media Gateway responding to said message, it sending back said TransactionID or event RequestID with the ID of said Call control Unit at the same time; the Distribution Unit in said Media Gateway Controller sending said response message to the corresponding Call Control Unit for processing depending on the ID of said Call control Unit. In the present invention, through adding the CCU_ID in the TransactionID and event RequestID, causing the Distribution Unit in MGC to be able to distribute the messages to corresponding CCUs accurately and quickly, thereby improving the efficiency of message distribution.

### FIELD OF THE INVENTION

The present invention relates to a method of message distribution between Media Gateway Controller and Media GateWay, in particular, to a method of message distribution between Media Gateway Controller and Media GateWay in high-capacity exchange, which belongs to the field of communication switching technologies.

### BACKGROUND OF THE INVENTION

Modern exchanges are all high-capacity and highly reliable devices, which requires that one exchange is able to serve hundreds of thousands of or even millions of subscribers at the same time. Referring to FIG. 1, an exchange usually operates by cooperation of multiple call control units (referred to as CCU hereinafter) in order to meet the requirement for high-capacity, each CCU is able to handle tens of thousands of calls; multiple CCUs in the exchange cooperate so as to be able to handle millions of calls.

Referring to FIG. 2, a Next Generation Network (NGN) is a network in which the service control and the bearing media are separated from each other, wherein, the service control part is known as Media Gateway Controller (MGC), while the bearing part is known as Media GateWay (MGW). The communication interface between MGC and MGW is defined in H.248 (a H-series protocol of INTERNATIONAL TELECOMMUNICATION UNION) and Media Gateway Control Protocol (MGCP).

With the requirement for high-capacity, there are provided multiple CCUs in a MGC. Usually, an exchange can decide by which CCU a call will be handled at the beginning depending on the data configuration or other distribution policies. In order to establish a call, CCU in MGC will send request message to MGW, and MGW will send response message to MGC in turn. However, in the case of the presence of multiple CCUs, it should be guaranteed that messages from MGW be distributed to different CCUs properly.

Referring to FIG. 3, on Distribution Unit, there is recorded the information of all calls and of by which CCUs the corresponding calls are being handled currently. Message sent back from MGW will reach Distribution Unit first; after receiving the message sent back from MGW, Distribution Unit will query its record table, and then decides to which CCU the message sent back from MGW should be distributed.

In the way of processing described above, firstly, it is necessary for said exchange to maintain a bulky table; and secondly, it is also necessary to ensure the correctness of the content recorded in this table, that is: to ensure the CCU which handles certain call in practice to be consistent with the content recorded in this table; finally, the querying efficiency may be very low since said table is bulky.

### SUMMARY OF THE INVENTION

It is an object of the present invention to provide a method of message distribution between Media Gateway Controller and Media GateWay, which can ensure the correctness of message distribution and higher distribution efficiency when Media GateWay responds to message from Media Gateway Controller, without the need of maintaining a bulky table.

It is another object of the present invention to provide a method of message distribution between Media Gateway Controller and Media GateWay, according to which messages are distributed when the Media Gateway sends response messages and event detected messages to Media Gateway Controller, and which can ensure the correctness of message distribution and higher distribution efficiency, without the need of maintaining a bulky table.

The present invention solves the above mentioned technical problems by the following technical solutions:

A method of message distribution between Media Gateway Controller and Media GateWay, wherein each Call Control Unit in the Media Gateway Controller having corresponding ID; when the Media Gateway Controller sending request message to the Media Gateway, the ID of said Call control Unit being recorded in TransactionID in said request message; when the Media Gateway sending back response message, it sending back the TransactionID with the ID of said Call control Unit at the same time; when the Distribution Unit in said Media Gateway Controller receiving said response message, it extracting the ID of said Call control Unit from said TransactionID, and sending said response message to the corresponding Call Control Unit for processing depending on the ID of said Call control Unit.

A method of message distribution between Media Gateway Controller and Media GateWay, characterized in that, each Call Control Unit in the Media Gateway Controller having corresponding ID; when the Media Gateway Controller requesting the Media GateWay to detect an event, it designating a RequestID corresponding to said detection event, and recording the ID of said Call control Unit in said RequestID; when the Media GateWay detecting the requested event, it sending a event detected message to said Media Gateway Controller, meanwhile, sending said RequestID with the ID of said Call control Unit; after the Distribution Unit in said Media Gateway Controller receiving said event detected message, it extracting the ID of said Call control Unit from said RequestID, and sending said event detected message to the corresponding Call Control Unit depending on the ID of said Call control Unit for processing.

The Media GateWay of the present invention causes the Distribution Unit to distribute messages onto the respective Call Control Unit precisely by adding the ID of said Call control Unit into the TransactionID and RequestID in response to message from Media GateWay Controller, without the need of maintaining a bulky record table, thereby improving the distribution efficiency of message distribution.

### BRIEF DESCRIPTION OF THE DRAWINGS

FIG. 1 is a schematic of the structure of an exchange according to an embodiment of the present invention;

FIG. 2 is a schematic of the communication protocols between Media Gateway and Media GateWay Controller according to an embodiment of the present invention;

FIG. 3 is a schematic of message distribution between Media GateWay and Media GateWay Controller according to an embodiment of the present invention.

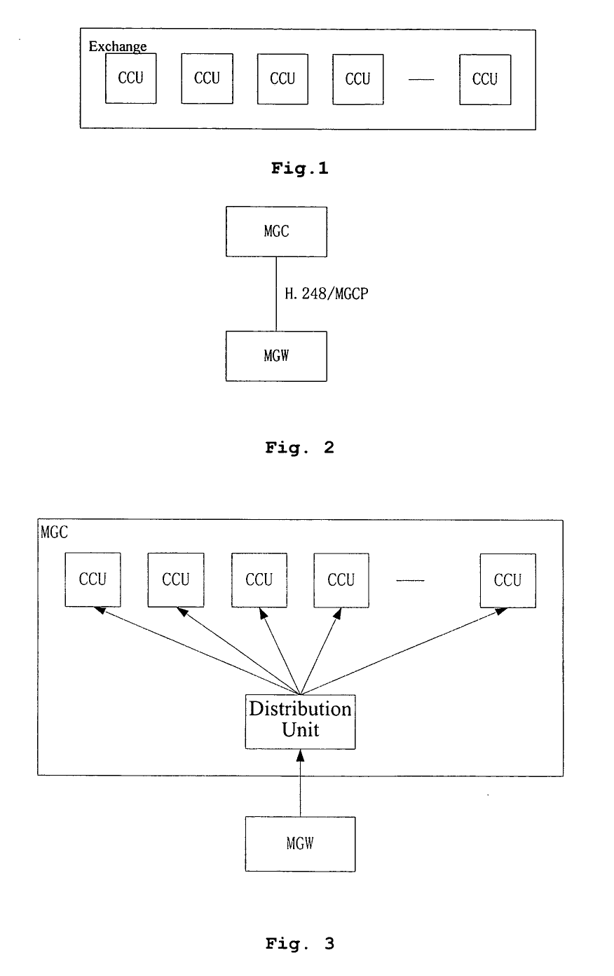

### DETAILED DESCRIPTION OF THE EMBODIMENTS

Hereinafter the present invention will be described in further details in conjunction with particular embodiments and the attached drawings:

According to H.248 protocol, a message between MGC and MGW may contain one or more transactions, each of the transactions may have a transaction ID, denoted as TransactionID. Said transactions include requests and responses. The TransactionID of a request transaction are designated by the message sender, while the TransactionID of a response transaction must be identical to the TransactionID in the request message.

Transactions are generally initiated by MGC, that is, request messages are sent to MGW by MGC, while MGW sends back response messages to MGC. In another case, transactions may also be initiated by MGW. MGC may request MGW to detect some events. When MGW detects such events, it will report to MGC initiatively; here, the TransactionID of the report message is distributed by MGW. It is also specified in H.248 and MGCP protocols that: when MGC requests MGW to detect some events, MGC will designate a RequestID corresponding to this event to be detected; when MGW detects that requested event, it will add this RequestID into the message reported to MGC. For information about transaction processing in H.248 protocol, please refer to the book “Soft Switch-Based NGN Technology” issued by Post and Telecom Press in August 2002, which describes in detail the composition, sending, and response of transaction messages.

Hence, in the present invention, messages sent by MGW to MGC are distributed to the individual CCUs correctly and efficiently utilizing TransactionIDs and RequestIDs allocated by MGC.

Specifically, first, each CCU in MGC is provided with an ID, which is denoted as CCU_ID, and may comprises 1 byte or multiple binary bits (in this description, only 1-byte is taken as an example). Both of said TransactionID and said RequestID include 4 bytes; when MGC allocates TransactionID and RequestID, some bits of them are filled, for example, the most significant 1 byte, with CCU_ID. MGC can distribute response messages and event detected messages properly to any CCU for corresponding service or transaction processing according to CCU_ID.

1. Response Message

In request message sent to MGW, MGC fills the most significant byte of TransactionID with CCU_ID; when MGW sends back response message, this TransactionID is carried, the response message reaches the Distribution Unit first; the Distribution Unit extracts the TransactionID therein and takes out CCU_ID thereof, and then the message is distributed to the corresponding CCU depending on the extracted CCU_ID. In the above operations, said filling operation refers to write said CCU_ID represented with 1 byte in the above example into the most significant byte of said TransactionID; thus, it causes said TransactionID to be able to carry the CCU_ID. When the Distribution Unit extracts CCU_ID from TransactionID, it only needs to read out the most significant byte of TransactionID to obtain said CCU_ID, since said CCU_ID is filled in the most significant byte of TransactionID.

2. Event Detected Message

When MGC requests MGW to detect an event, it designates a RequestID corresponding to the detection, and fills the most significant byte of the RequestID with the CCU_ID. When MGW detects the requested event, it reports to MGC through message, this report message includes the RequestID which carries the specified CCU_ID. The report message reaches the Distribution Unit first; the Distribution Unit recognizes that this is a message reported initiatively from MGW, then extracts the RequestID therefrom, and takes out CCU_ID thereof, finally, it distributes the report message to the corresponding CCU for processing depending on the CCU_ID. The Above described filling and extracting process for RequestID is identical to the filling and extracting process for TransactionID, thus will not be detailed herein.

Finally, it should be noted that the above embodiments are intended only to illustrate the present invention and not to limit the technical solutions described in the present invention; though the present invention has been explained with reference to the individual embodiments described above, those skilled in the art shall understand that modifications or equivalent replacements can be made to the present invention; all the technical solutions not departing from the spirit and scope of the present invention and their improvements should be covered within the scope of the claims of the present invention.

1. A method of message distribution between a Media Gateway Controller and a Media GateWay, comprising the steps of:
the Media Gateway Controller recording the ID of a Call Control Unit in a TransactionID of a request message, and sending the request message to the Media Gateway,
wherein each Call Control Unit in the Media Gateway Controller has a corresponding ID;
the Media GateWay sending back to the Media Gateway Controller a response message and simultaneously sending back the TransactionID with the ID of the Call Control Unit; and
after receiving the response message, a Distribution Unit in the Media Gateway Controller extracting the ID of the Call Control Unit from the TransactionID, and sending the response message to the corresponding Call Control Unit for processing based on the ID of the Call Control Unit.

2. The method according to claim 1, wherein the ID of the Call Control Unit comprises 1 byte or multiple binary bits.

3. A method of message distribution between a Media Gateway Controller and a Media GateWay, comprising the steps of:
the Media Gateway Controller designating a RequestID corresponding to an event, recording the ID of a Call Control Unit in the RequestID of a request message, and sending to the Media GateWay the request message requesting the Media GateWay to detect the event,
wherein each Call Control Unit in the Media Gateway Controller has a corresponding ID;
the Media Gateway detecting the requested event, sending an event detected message to the Media Gateway Controller, and simultaneously sending the RequestID with the ID of the corresponding Call Control Unit;
after receiving the event detected message, a Distribution Unit in the Media Gateway Controller extracting the ID of the Call Control Unit from the RequestID, and sending the event detected message to the corresponding Call Control Unit based on the ID of the Call Control Unit for processing.

4. The method according to claim 3, wherein the ID of the Call Control Unit comprises 1 byte or multiple binary bits.

5. The method according to claim 1, wherein the steps of the Media GateWay sending back a response message and simultaneously sending back the TransactionID with the ID of the Call Control Unit are performed according to the H.248 and MGCP protocols.

6. The method according to claim 3, wherein the steps of the Media Gateway sending an event detected message to the Media Gateway Controller and simultaneously sending the RequestID with the ID of the corresponding Call Control Unit are performed according to the H.248 and MGCP protocols.
